(19) United States
(12) Patent Application Publication
(10) Pub. No.: US 2022/0387934 A1
(43) Pub. Date: Dec. 8, 2022

(54) Apparatus and Process for Filtering and Mineralizing a Fluid

(71) Applicant: Alexandre Mahe, London (GB)

(72) Inventor: Alexandre Mahe, London (GB)

(21) Appl. No.: 17/770,132

(22) PCT Filed: Oct. 22, 2020
(86) PCT No.: PCT/CA2020/000120

§ 371 Date: Apr. 19, 2022

Related U.S. Application Data
(60) Provisional application No. 62/924,606, filed on Oct. 22, 2019.

(51) Int. Cl. B01D 61/10; B01D 61/02; B01D 61/08; C02F 1/44; C02F 1/68; C02F 1/32

(52) U.S. Cl. CPC B01D 61/10; B01D 61/025; B01D 61/081; C02F 1/441; C02F 1/686; C02F 1/325; B01D 2311/06; B01D 2313/44; B01D 2313/243; B01D 2313/22; B01D 2313/50; B01D 2313/60; C02F 2303/04; C02F 2201/3222; C02F 2201/006; C02F 2209/40; C02F 2307/10

(57) ABSTRACT

An apparatus for filtering and mineralizing a fluid. The apparatus includes an amount of contaminated fluid located in a reservoir and a cartridge that is located downstream from the reservoir and in fluid communication with it. A filter is in fluid communication with the reservoir and the cartridge. The contaminated fluid is pumped along a pathway from the reservoir to the cartridge so that the contaminated fluid moves through the filter to generate filtered fluid in the cartridge. A pre-determined amount of an additive is associated with the cartridge for adding to the filtered fluid to generate a final fluid with the amount of the additive material.

### TECHNICAL FIELD

The present relates generally to water purification, and more particularly to an apparatus and process for sterilizing contaminated water to make it potable and to customize its mineralization.

### BACKGROUND

Providing clean, potable water from contaminated water that is unfit for human use is one of the world's biggest challenges, especially in impoverished areas. Enteric diseases caused by consuming contaminated water causes premature death, particularly amongst infants, at an alarming rate. Also, to access water, many families must walk to wells or rivers, which may be a significant distance from their homes. The journey to such wells may be fraught with danger such as attacks from wild animals.

Human activities such as farming, industry, animal activity, household sewage, and the like pollute the water, which washes downstream to wells where it collects.

Current methods to generate potable water involves purifying contaminated water using boiling, and distillation. While these methods do provide potable water on a limited scale, the processes typically remove minerals that are required for human consumption.

Common filtration methods widely available today such as carbon filtration in the form of filter jugs do not offer the purification level required to be used in a contaminated tap water environment. This is the reason why most of the countries with contaminated tap water often consume exclusively bottled water.

Notwithstanding the poor accessibility to clean drinking water, the problems associated with the current method of water purification (Reverse Osmosis or Distillation) can remove minerals that are vital for people with specific dietary needs. Such people include pregnant women, people who are lactose intolerant, and vegans, who must obtain daily doses of vitamins, minerals, nutrients, and micro-nutrients from non-plant sources. Moreover, local tap water is generally deficient in minerals, which are removed during large scale decontamination processes that are prevalent in large urban areas, and thus the people mentioned above cannot rely on freely available water for their specific dietary needs.

A short-term solution is the current trend of buying bottled mineralized water. This, however, has resulted in an increase in the number of discarded plastic water bottles, which is quickly becoming a huge environmental problem. Of course, the number of discarded plastic water bottles can be reduced by persuading people to reuse the plastic water bottles, but this is a huge task, especially if using plastic bottles has become a habit. Also, currently available purification devices, such as Brita™ dispensers and pitchers, only remove certain contaminants from the impure water but fails to replenish the minerals needed for good health.

A number of groups have attempted to address these specific problems by designing systems that purify and re-mineralize water. Although these systems, are useful for people having normal mineral requirements, they do not provide unique and specific requirements of, for example, pregnant women, people who are lactose intolerant, and vegans, each of whom require vitamins, minerals, nutrients, and micro-nutrients that are unique to them. These systems also do not allow for an accurate amount of minerals to be dispensed in the purified water in a controlled manner. Thus, making them unable to produce an exact mineral or micronutrient composition.

Several examples of apparatus and methods to purify and re-mineralize water are provided below:

Published PCT application WO2018141883 to Mitt for “Water Purification System and Distillation Unit”;

Chinese patent number CN105263870B for “Equipment Suitable for Preparing Remineralization of Aqueous Solution of Calcium Bicarbonate”

U.S. Pat. No. 7,507,334B1 to Sigona for “Water Treatment System”;

U.S. Pat. No. 7,165,488B2 to Bragg for “Brew Chamber for a Single Serve Beverage Brewer”;

European Patent number EP2310327B1;

Australian Patent number AU2012301003B2;

Published PCT application number WO1993025478 to Pirone for “Process and Apparatus for the Production, Particularly Domestic Production, Of Beverages”

U.S. Pat. No. 5,443,739A to Vogel for “Water Purification and Dispenser with Uncontaminated Mineral Solution”.

Disadvantageously, the designs described above fail to disclose a bespoke water re-mineralization system that is designed to produce water that is mineralized to meet the specific vitamin and mineral needs of a user. These vitamin and mineral needs are often strongly related to the user's lifestyle and diet. In one example, a re-mineralization and reverse osmosis filter system is described where the water passes through a single reverse osmosis filter twice. The filtered water can then be re-mineralized so that the filtered water's pH will be between 7.5-8.5 with an average of 8. The significant disadvantage is that the mineralization of the water is not accessible to being tailor-made.

Thus, there is a need for an apparatus and process that provides a user with the ability to generate filtered water that has user-specific micronutrients in a sustainable, cost-effective and easy manner.

### BRIEF SUMMARY

We have designed a novel and unobvious system that significantly reduces, or essentially eliminates, the problems associated with the designs described above. Our method uses a filtration that sterilizes contaminated water and then introduces specific minerals and vitamins into the sterilized water in a custom manner so that the water is then suitable for use by people with certain dietary needs.

Advantageously, our apparatus allows the user to cost-effectively and efficiently produce purified mineral water from tap water, or indeed any raw and unpurified water source. The apparatus is more convenient, more environmentally friendly, and a healthier alternative compared to buying commercially available bottled water. Furthermore, given the re-mineralization aspect of the apparatus, users will be able to customize what minerals and vitamins are present in their water. The user buys the device once and then buys the biodegradable cartridge filled with the desired vitamin and mineral composition and reverse osmosis membranes at a fraction of the cost of commercially available bottled water. The control of nutrients is useful to eliminate human micronutrient deficiencies. Indeed, micronutrient deficiencies is a very well reported problem in countries with poor access to food and water. Our process and apparatus seek to significantly reduce the impact bottled water has on the environment by encouraging people to use local tap water to promote health and well-being.

Accordingly, in one embodiment there is provided an apparatus for filtering and mineralizing a fluid, the apparatus comprising:

an amount of contaminated fluid located in a first reservoir;

a cartridge located downstream from the first reservoir and in fluid communication therewith;

a filter member in fluid communication with the first reservoir and the cartridge, the contaminated fluid being pumped along a fluid pathway from the first reservoir to the cartridge so that the contaminated fluid contacts the filter member and moves therethrough so as to generate an amount of a filtered fluid in the cartridge; and

a pre-determined amount of an additive material associated with the cartridge for adding to the filtered fluid so as to generate an amount of a final fluid having therein the amount of the additive material.

In one example, a second reservoir is connected to the cartridge to receive therein the amount of the final fluid.

In another example, the apparatus further includes: a pump; a first conduit connected to the first reservoir and the pump; and a second conduit connected to the pump and the cartridge,

In one example, the cartridge includes a cartridge sidewall, the cartridge sidewall having an inlet opening and a sealed exit opening. The sealed exit opening includes a breakable seal. The breakable seal is a mineral seal. The mineral seal is formed from two mineral seals that are ruptured when pierced by a needle. The mineral seal is formed from a single mineral seal that ruptures when the pressure within the cartridge exceeds a pre-defined value. The filtered fluid is pumped into the cartridge at a pressure sufficient to break the breakable seal to release the final fluid into a second reservoir.

In yet another example, the first conduit and the pump are located in a housing. The filter member is located between the pump and the cartridge. The filter member is located in the second conduit between the pump and the cartridge. The filter member is a reverse osmosis filter.

In another example, the cartridge includes a centrally located tube connected to the sealed exit opening, the centrally located tube having a plurality of holes located along substantially the entire length of the tube. The filter member is located snuggly adjacent the centrally located tube, the first fluid flowing along the fluid pathway through the filter member into the centrally located tube. The filter member is a reverse osmosis filter membrane. The filter member removes impurities from the contaminated fluid that are greater than 0.0001 micron. The filter member is located between the first reservoir and the cartridge.

In another example, the cartridge is a single-use cartridge.

In yet another example, the additive material is a re-mineralization solution contained in a chamber of the cartridge.

In one example, the centre tube includes the additive material. The additive material includes user specific minerals, vitamins, nutrients, and micro-nutrients. The additive material is a liquid concentrate solution. The additive material is a powder.

In still another example, the pump includes one of a centrifugal pump and a positive displacement pump. The pump pressurizes the first fluid to a predefined pressure between 80 PSI and 130 PSI pressure.

In one example, the apparatus further includes a refrigeration unit to cool the filtered fluid and the final fluid exiting the cartridge.

In one example, the apparatus further includes an instant heating module to provide boiling purified or mineralised water.

In one example, the pump is an RO booster diaphragm pump. The diaphragm pump operates at a pressure up to 130 PSI. A peristaltic pump connects the additive material to the cartridge so as to dispense additive material thereinto.

In another example, the apparatus further includes a flow meter or a flow rate sensor located downstream of the cartridge.

In another example, the apparatus further includes a load cell or weight sensor module located downstream of the cartridge.

In another example, the apparatus further comprises of level sensors in each tank to pre determine the amount of water present in the tanks.

In another example, a UVC LED is located in the second reservoir to ensure that the purified water remains sterile while hold in an intermediary tank.

In yet another example, the fluid is water.

Accordingly, in another embodiment, there is provided a process for filtering and mineralizing contaminated water, the process comprising:

filtering an amount of contaminated water from a first reservoir by pumping the contaminated water from the first reservoir through a filter member into a cartridge, the cartridge being located downstream of the first reservoir so as to generate an amount of filtered water; and

adding a predetermined amount of an additive material to the filtered water so as to generated a final water product, the pressure in the cartridge being sufficient to expel the final water product out of the cartridge and into a second reservoir.

Accordingly, in an alternative embodiment, there is provided a sterilization and re-mineralization system including an impure water housing, a pump, tubing that connects the impure water housing to the pump, a cartridge wherein re-mineralization minerals include user specific minerals, vitamins, nutrients, and micro-nutrients, tubing that connects the pump to the cartridge and a final reservoir to hold the purified and re-mineralized aqueous solution. In some embodiments, the cartridge is single use. In some embodiments the cartridge includes a filter to remove impurities larger than 0.001 micron. In some embodiments a filter is interposed between the pump and the cartridge. In some embodiments the re-mineralization solution is contained in a chamber of the cartridge. In some embodiments the cartridge includes a filter.

### BRIEF DESCRIPTION OF FIGURES

These and other features of that described herein will become more apparent from the following description in which reference is made to the appended drawings wherein:

FIG. 1 is a detailed longitudinal cross-sectional cut-through view of an embodiment of an apparatus for making a sterile and re-mineralized aqueous solution from impure water where the cartridge includes a reverse osmosis membrane and the re-mineralization solution;

FIG. 2 is a front view of the apparatus showing a reverse osmosis membrane, ae re-mineralization solution cartridge and a final reservoir (water bottle);

FIG. 3 is a top view of the apparatus of FIG. 2;

FIG. 4 is an exterior view of a cartridge containing a reverse osmosis membrane and a re-mineralization solution;

FIG. 5 is a longitudinal cross-sectional cut-away view of the cartridge illustrated in FIG. 4;

FIG. 6 is a detailed longitudinal cross-sectional cut-through view of an alternative embodiment of an apparatus for making a sterile and re-mineralized aqueous solution from impure water showing a cartridge with a re-mineralization solution excluding a reverse osmosis membrane;

FIG. 7 is an exterior view of a cartridge that contains the remineralization solution and excludes the reverse osmosis;

FIG. 8 is a cross sectional longitudinal cut-away view of the cartridge illustrated in FIG. 7;

FIG. 9 is an exterior view of a reverse osmosis membrane cartridge used by the apparatus illustrated in FIG. 6;

FIG. 10 is a longitudinal cross-sectional cut-away view of the reverse osmosis membrane cartridge illustrated in FIG. 9;

FIG. 11 is an external view of a reverse osmosis membrane cartridge including a chamber to hold re-mineralization solution;

FIG. 12 is a longitudinal cross-sectional cut-away view of the reverse osmosis membrane cartridge including a chamber to hold re-mineralization solution illustrated in FIG. 11;

FIG. 13 is a detailed view of an alternative embodiment of the apparatus showing a peristaltic pump connected to an additive container; and

FIG. 14 is a detailed circuit diagram showing the embodiment of FIG. 13.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

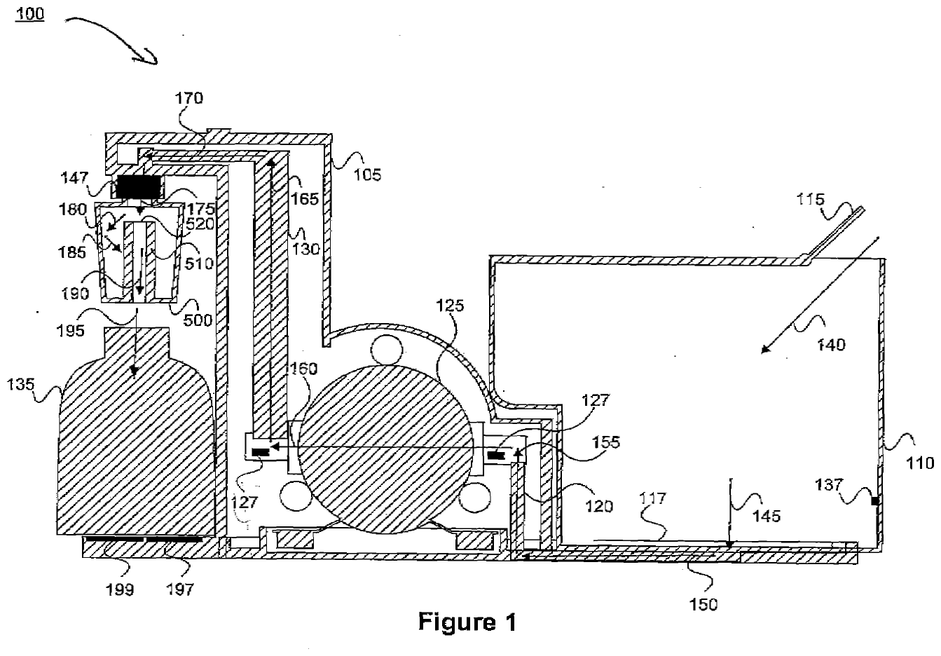

Referring now to FIG. 1, there is shown generally at 100 an apparatus used to produce customer-specific purified water from contaminated water or, in some cases, local tap water. In both cases, the degree of contamination depends on the source. For example, the level of contamination will of course be considerably higher in places such as impoverished areas where water is collected from wells or rivers, compared to municipal water which has been previously sterilized but has removed most of the mineral content needed for healthy mammalian consumption, particularly for human consumption. For home use, particularly in areas where municipal water is freely available, the apparatus 100 can be used as a counter-top appliance, which can be moved easily and repositioned to a location desired by the user. Depending on the desired use and location of the water source to be filtered and re-mineralized, some designs of the apparatus are portable and require an external power source such as connection to the electricity grid. In other examples, the apparatus may include an independent power source such as a battery. In areas that may be considered “off grid”, the power source cab ne solar power or indeed any other alternative energy sources.

It should be noted that the description uses the term “fluid”, which a person skilled in the art will recognize is a generic term which covers liquid and gas. In the examples used throughout, the fluid is water.

Generally speaking, our apparatus combines a Sediment+Carbon and Reverse osmosis membrane into a single filter housing designed to promote a user-centric design. Our cartridge has a lifespan of 6 to 12 months depending on consumption. The sediment and carbon filters are presented as a single module containing the specific elements. Moreover, our apparatus is able to dispense a liquid drop-by-drop by using a peristaltic pump capable of dispensing at a rate as low as 0.5 mL/min. A significant advantage that our apparatus realizes is the combination of the reverse osmosis plus liquid mineralisation plus peristaltic pump which allows us to recreate any currently available water brand. This is done by carefully selecting the correct liquid concentrate and dosage. We are now able to add vitamins to the water produced given the use of the liquid mineralisation system. Conventional water purification devices mostly use “hard remineralisation” using a combination of granules, but these cannot be used with vitamins since hard mineralisation granules cannot currently be enriched with vitamins.

Generally speaking, reverse osmosis systems “Waste Water” or “Brine Water” as a by-product. This water contains the impurities that are collected by the reverse osmosis membrane. The flushing avoids the reverse osmosis membrane from clogging (commonly referred to as “membrane fouling”). Most conventional systems ask that this water be discarded, when not done automatically. This brine water is very rich in dissolved solids and minerals. In one embodiment, our design collects the brine water in a separate tank that encourages the user to use it to water house plants or their gardens given the nutritional value of this water for plants.

Our mineral concentrate can be supplied in bottles with a foil seal at the top of the bottle. The bottles would be easily recyclable or ideally made from recycled plastic. This avoids extra cost in having cartridges made and filled with a concentrate, which has a risk of potential contamination and (the more expensive) cartridges would be difficult to recycle (multi-material).

Broadly speaking, the apparatus 100 includes a first reservoir (a housing for pre-treated or contaminated water) 110 for storing or collecting an amount of contaminated water therein. The reservoir 110 is sized and shaped to define an impure or non-treated water storage space. The reservoir 110 includes a closable opening 115 located on the side of the reservoir 110 which permits the pre-treated water to be poured into the reservoir 110. The closable opening 115 can be of a relatively large diameter or radius in order to allow users to clean the inside of the reservoir 110 when required. The reservoir 110 requires cleaning since the impure water placed into the impure water housing 110 often contains impurities such as limestone that accumulate over time.

Fluidly connected to the reservoir 110 and downstream therefrom is a pump 125 of specific strength and capacity. A conduit 120 in the form of a first tubing is connected to the pump 125 from a pump inlet to the impure water reservoir 110. A single use water re-mineralization and filter cartridge 500 sized and shaped for connection to the outlet of the pump 125 by means of a second conduit 130 in the form of a second tubing. A collection reservoir 135 sized and shaped to collect a final water product is located beneath the single use re-mineralization and filter cartridge 500 to receive and store the sterile re-mineralized aqueous solution (the final water product). The collection reservoir 135, the first reservoir 110 and the cartridge 500 are located in fluid communication with each other. The collection reservoir 135 is located downstream of the cartridge 500, which in turn is located downstream from the first reservoir 110. The fluid is pumped along a fluid pathway from the first reservoir 110 to the collection reservoir 135. The single use cartridge can be discarded or recycled after each use. It should be noted though that the entirety of the liquid or mineral concentrate (the additive) present is used after each purification cycle.

In one example, the first and second conduit (tubing) 120, 130 are made from made of polyethylene plastic which is resistant to high pressure as well as being physically flexible.

The first reservoir 110 is typically a heat resistant hollow construction of rectangular or cylindrical shape, with a capacity of about 500 milliliters to 3.5 liters. The first reservoir 110 is generally manufactured using an injection molding process and using adequate transparent or semi-transparent material such as ABS or Nylon.

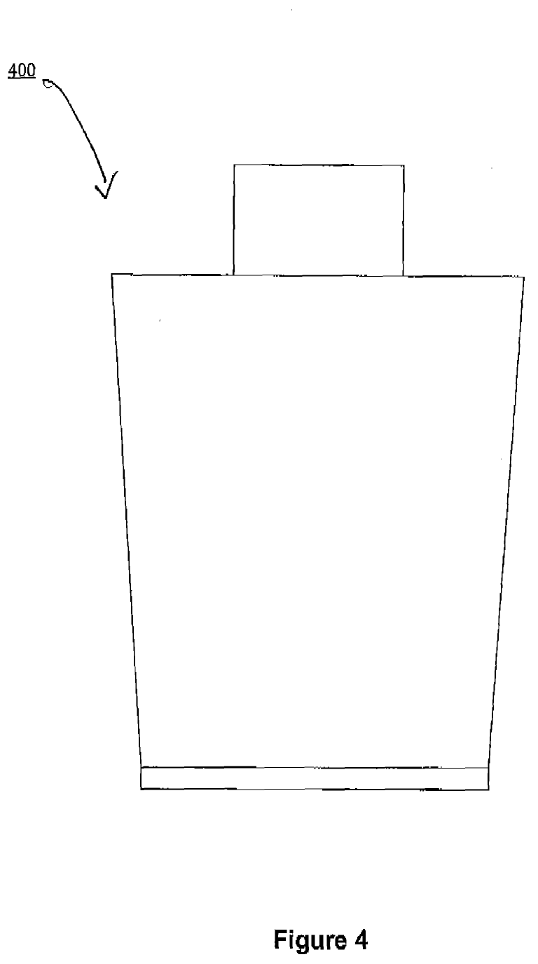

Referring now to FIG. 4, an outer surface 400 of the single use re-mineralization and filter cartridge 500 described herein to purify and re-mineralize impure water is formed using biodegradable and compostable materials such as bamboo, bamboo fibre or bioplastics such as Plastarch™.

A housing 105 that is sized and shaped to hold the pump 125, the conduits 120, 130 includes an extruded base on which the reservoir 110 and the collection reservoir 135 rest. The single use re-mineralization and filter cartridge 500 is connected to the extruded housing 105.

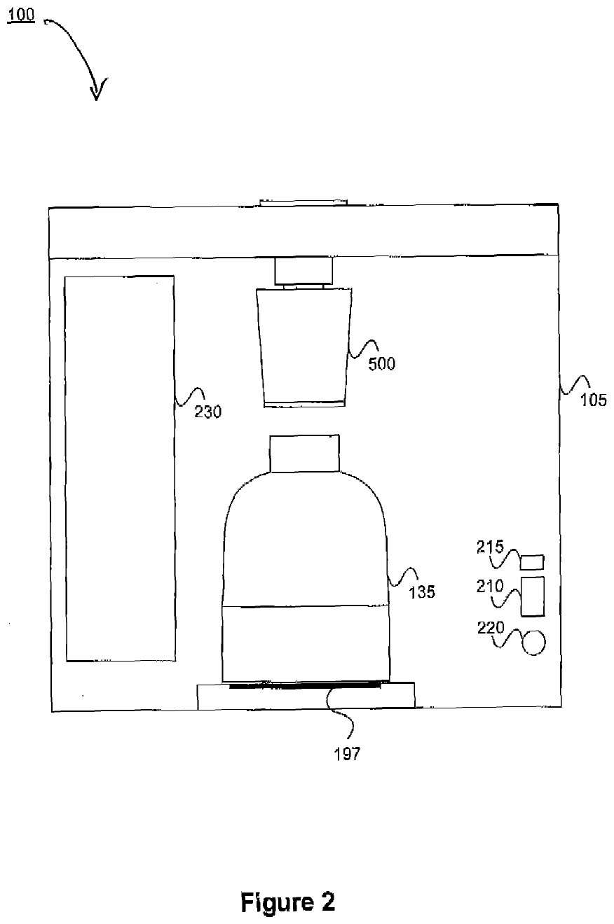

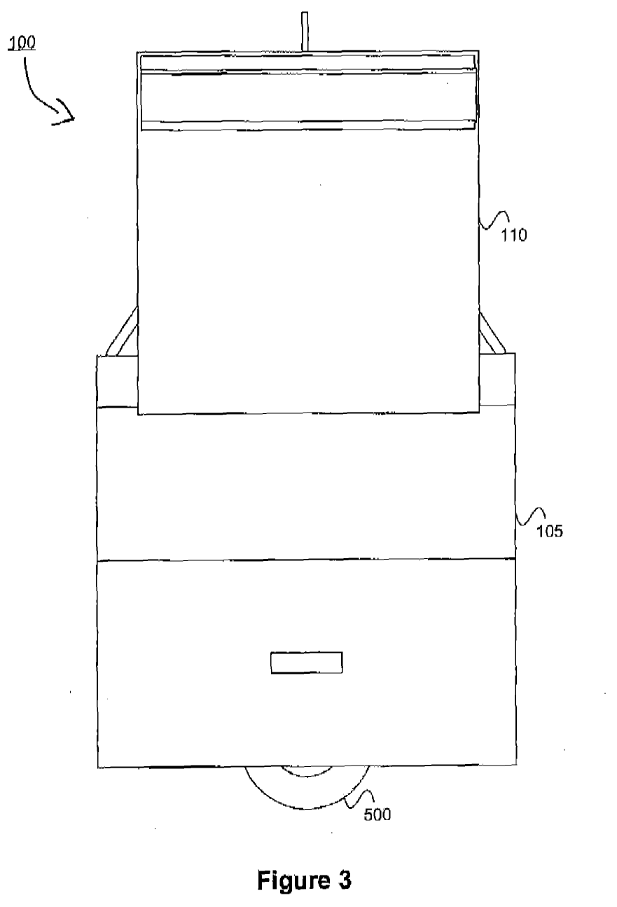

Referring now to FIGS. 2 and 3, the various components of the apparatus 100 are illustrated to ensure an aesthetically pleasing and compact appearance. As best seen in FIG. 2, located in the bottom right-hand corner is a power switch 210. The top view of the apparatus 100 clearly shows the relative positions and placement of the impure water housing 110 and the single use re-mineralization and filter cartridge 500 on the extruded housing 105.

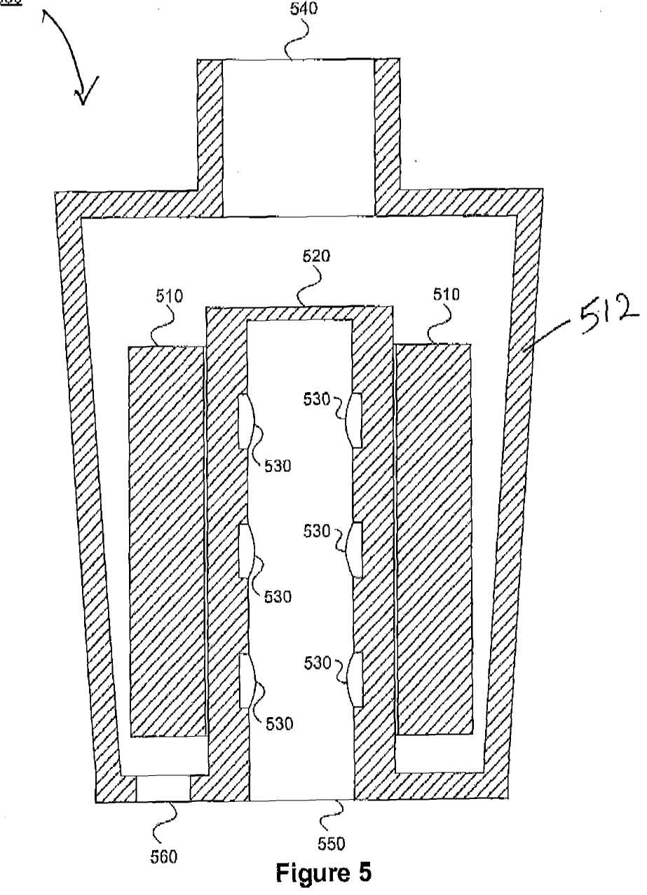

Referring back to FIG. 1 and now to FIGS. 4 and 5, the cartridge 500 is connected to an end portion of the second conduit 130. A filter member 510 is in fluid communication with the first reservoir 110 and the cartridge 500. The filter member 510 is located snuggly against a centrally disposed tubing 520 that includes along the entirety of its length a plurality of spaced apart holes 530. The cartridge 500 includes a cartridge sidewall 512, an inlet opening (port) 540, a sealed exit opening 550 and an exit opening 560 located near the bottom of the cartridge to release overflow water. The contaminated water is pumped along a fluid pathway as shown by following arrows in order of 144 to 155 to 165 to 175 to 190 to 195 from the first reservoir 110 to the cartridge 500 so that the contaminated water contacts the filter member 510 and moves therethrough so as to generate an amount of a filtered fluid in the cartridge 500. The filtered water collects in the centrally disposed tubing 520. The pump 125 operating at a specific pressure range causes the internal pressure to break the sealed exit opening 550 thereby releasing the final water product into the collection reservoir 135.

Referring back now to FIG. 1, one of the advantages of the apparatus 100 is its autonomy. The user can leave the apparatus 100 to carry out a filtering and re-mineralization operation without fear of spillage of the final water product. The collection reservoir 135 is located on a sensor 197 which determines when it is full. The sensor 197 can be selected from one of many commercially available sensors. In one example, the sensor is a weight sensor or an ultrasonic sensor. In the example illustrated, the sensor is a weight cell 197 which determines that the weight of the collection reservoir 135. Once a pre-determined amount of final water product is located in the final reservoir 135, the sensor 197 signals the apparatus to stop pumping. Alternatively, the weight cell 197 can be used to determine when the collection reservoir 135 is full when the weight of the collection reservoir 135 and the purified and re-mineralized aqueous solution contained within the collection reservoir 135 exceeds a threshold specified by the user.

The sensor 197 is desirably located at the base of the collection reservoir 135, where the collection reservoir 135 rests oil the extruded housing 105. In order to accurately determine the amount of water collected in the collection reservoir 135, the sensor 197 subtracts the weight of the collection reservoir 135 from the total weight measured by the sensor 197, if it is a weight sensor. The apparatus 100 determines the weight of the collection reservoir 135 using a calibration process that is initiated when the user depresses a calibration push button 220, as best seen in FIG. 2. The calibration process allows the user flexibility to reuse their own plastic water bottles. A Light Emitting Diode (LED) 215 is located near the power switch 210 is intended to notify the user that the contaminated water has been purified and re-mineralized and is now ready for consumption.

Referring back to FIG. 5, the contaminated water enters the single use re-mineralization and filter cartridge 500 through the inlet opening 540. The impure water then enters the filter member 510. The filter member 510 removes impurities from the impure water as the impure water passes through the filter member 510. The now purified water exits the filter member 510 and enters the center tube 520 via the plurality of centre tube holes 530. In one example, the filter member 510 is a reverse osmosis filter membrane.

Still referring to FIG. 1, a pre-determined amount of an additive material associated with the cartridge 500 for adding to the filtered fluid so as to generate an amount of the final fluid having therein the amount of the additive material.

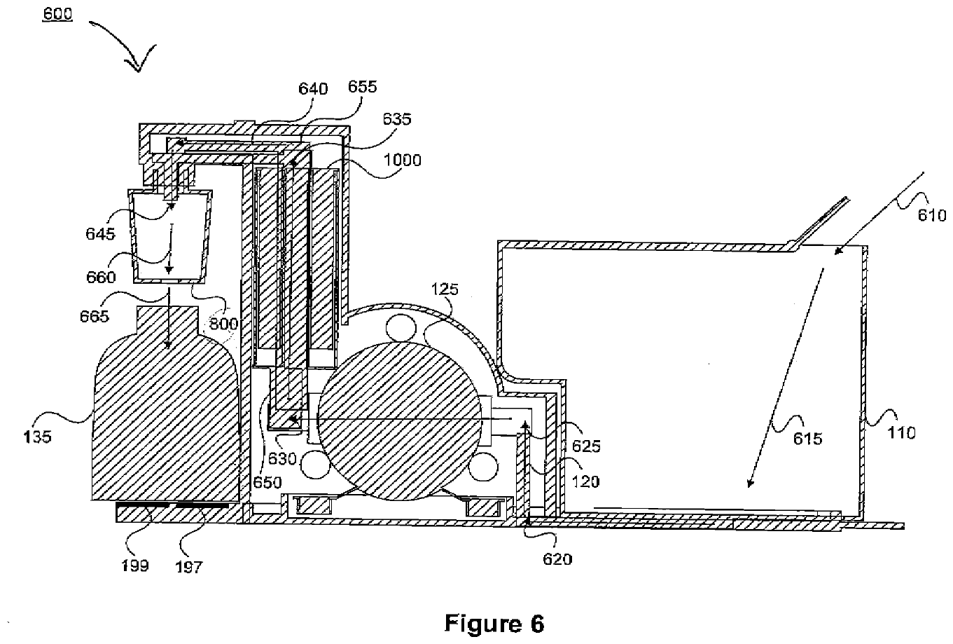

In the example shown in FIG. 6, the center tube 520 contains a re-mineralization concentrate that re-mineralizes the filtered water when combined with the filtered water in the center tube 520. The sealed exit opening 550 is a breakable seal 550, which when ruptured releases the final water product into the collection reservoir 135. The center tube 520 reduces our design's environmental footprint by being made from a water-soluble film (similar to dishwasher pods) such as polyvinyl alcohol (PVA or PVOH). The single use re-mineralization and filter cartridge 500 includes the mineral seal 550 that prevents the purified and re-mineralized aqueous solution from exiting single use re-mineralization and filter cartridge 500 until the mineral seal 550 is ruptured. In one example, the mineral seal 550 is formed from a single mineral seal. As the single use the re-mineralization and filter cartridge 500 fills with water, the pressure of water contained in the filter cartridge 500 increases. The water pressure continues to increases until it exceeds the threshold pressure required to causes the single mineral seal of the mineral seal 550 to rupture. In other examples, the mineral seal 550 is formed from two mineral seals which may be ruptured when pierced by a needle.

Water that does not enter the center tube 520 is not filtered and exits from the filter cartridge 500 via the exit opening 560. This water is known to a person skilled in the art as “back flow”. It is possible to permit this back flow to be reused by this apparatus by allowing it to exit the cartridge at the opening 560 and re-enter the first reservoir 110 and to be filtered later.

The pre-determined amount of the additive material re-mineralizes the filtered water by using a combination of minerals from a carbon filter, vitamins, minerals, and micro nutrients from a liquid concentrate solution. The additive material may also be a pre-made powder with specific concentrations of nutrients needed by certain users. The additives are not only limited to human consumption but can also be used by plants and animals.

The reverse osmosis membrane filter 510 used in the examples shown include a pore size that ranges from between 0.0001 micron and 0.001 micron as the filtration unit to filter contaminants that larger than 0.001 microns to produce a purified aqueous solution. The reverse osmosis membrane 510 used removes contaminants including microorganisms, Volatile Organic Compounds (VOCs), and Total Dissolved Solids (TDS) from impure water.

In one example, the contaminated impure water from the first reservoir 110 first enters a carbon pre-filter (not shown) that removes chlorine and other contaminants before this water enters the reverse osmosis membrane filter 510.

Water filtered by the reverse osmosis filter membrane 510 is pressurized by the pump 125 so that this water is able to pass through the reverse osmosis filer membrane 510 at the desired rate. The pump 125 ensures that the water is pressurized to a pressure that is greater than 50 PSI. A person skilled in the art will readily recognize that time to purify water increases when the pump 125 pressurizes water to a pressure less than 50 PSI. Water pressurized to less than 50 PSI will result in a slower feed rate of impure water and therefore increase the time required by the invention to purify the impure water. A person skilled in the art will also understand that the useful life span of the reverse osmosis filter membrane 510 is reduced if the pump 125 pressurizes water to a pressure greater than 80 PSI. Experimentation with this apparatus reveals that the feed rate increases by approximately 50 mL/min for every 10 PSI increase of the water pressure. The reverse osmosis filter membrane 510 employed herein is optimized for a single use delivery system rather than for a continuous mass purification process currently on the market. However, water purified using reverse osmosis technologies is difficult to consume unless minerals are added back into the filtered water. As noted above, for a tailor-made use, we have designed our apparatus to ensure a one-time use re-mineralization cartridge can add vitamins and minerals tailored to the individual's health requirements.

The pump 125 can be centrifugal or a positive displacement pump, having a shape adapted to allow it to be inserted into the extruded housing 105. The pump 125 will be preferably of 110V, 220V, 230V, 240V and 380V with a wattage ranging from around 600 to 5500 watts. In another example, the pump 125 is an RO booster diaphragm pump, which operates at a pressure up to 130 PSI.

The materiel used to construct the final reservoir 135 is such that the final reservoir 135 can be reused several times to hold the sterilized and re-mineralized aqueous solution produced by apparatus 100.

In one example, the final reservoir 135 is a two-part detachable water bottle. For example, the final reservoir 135 could be of 2 L capacity with a partition line located inside the final reservoir 135. Once filled, the final reservoir 135 can be separated into two 1 L bottles with individual caps for each opening of the respective bottle. This allows the user to take one of the 1 L bottles to work while leaving the second 1 L at home. In another example, one of the 1 L bottles could also be used as a jug to dispense the purified and re-mineralized aqueous solution directly into the user's glass or another bottle.

As best illustrated in FIG. 1, an ultrasonic sensor 199 is located in the final reservoir 135. The ultrasonic sensor 199 determines the level of purified re-mineralized aqueous solution in the final reservoir 135 by measuring the distance between the bottom of the final reservoir 135 and the surface of the purified re-mineralized aqueous solution. A water level sensor 117 may also be located in the first reservoir 110 to detect and determine the water level in the final reservoir 135. Alternatively, the water level sensor 117 can be located in the final reservoir 135 to determine the water level in the final reservoir 135. The flow meter 127 can be located before or after the pump 125 to detect the quantity of contaminated water that is entering the final reservoir 135.

As best illustrated in FIG. 2, an interactive screen 230 details relevant information regarding the process being executed by the apparatus 100 as well as other attributes of the purified and re-mineralized aqueous solution contained in the final reservoir 135. In one example, a timer located within the electronic layout of the interactive screen 230 determines the amount of purified and re-mineralized aqueous solution present in the final reservoir 135. In some examples, a timer (not shown) is able perform this timing function. A visual mark 137 that is an engraved visible horizontal line with the annotation including “MIN” on a side of the first reservoir 110. The visual mark 137 is intended to be used by the user to know the minimum amount of impure water to place in the impure water storage space to limit the possibility of an excessively concentrated purified and re-mineralized aqueous solution.

For certain user requirements, especially in hot countries, cool or cold water is very palatable. A refrigeration unit 147 is used to cool the purified and re-mineralized aqueous solution before entering the final reservoir 135. The refrigeration unit 147 is connected to the cartridge inlet 540.

### Alternative Embodiments

As best seen in FIG. 6, a more environmentally apparatus is shown generally at 600. The apparatus 600 uses a single use re-mineralization cartridge 800 that performs only re-mineralization and does not include a reverse osmosis filter. The apparatus 600 is more environmentally friendly than the apparatus 100 because the reverse osmosis filter 1000 is intended to be replaced after twenty uses and only the single use re-mineralization cartridge 600 is replaced each time the apparatus 600 is used.

In the case of the apparatus 600, the user places impure water into the first reservoir 110 as illustrated by arrows 610 and 615. Like the previous apparatus 100, the pump 125 draws the contaminated water from the first reservoir 110, through the tubing 120 and into the pump 125 as illustrated by arrows 620 and 625. As illustrated by arrow 635, the pump 125 then causes the contaminated water to exit the pump 125, to pass through first tubing 650, whereupon the contaminated water enters a reverse osmosis filter 1000 for filtration. The purified water exits the reverse osmosis filter 1000 and travels through second tubing 655 where it enters the single use remineralization cartridge 800 as illustrated by arrows 640 and 650. The purified and filtered water is re-mineralized as it passes though the single use remineralization cartridge 800 as illustrated by arrow 660. The now purified and re-mineralized aqueous solution exits the single use re-mineralization cartridge 800 and enters the collection reservoir 135 as illustrated by arrow 665.

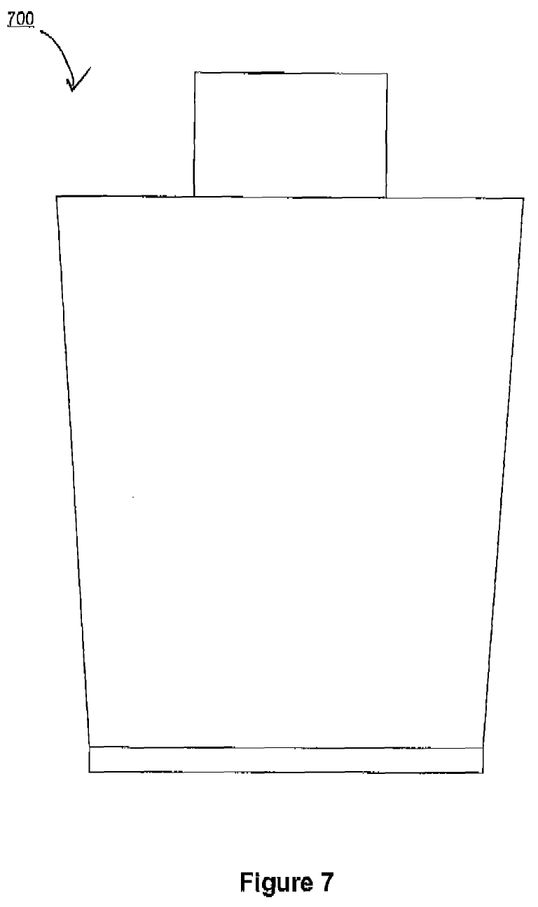

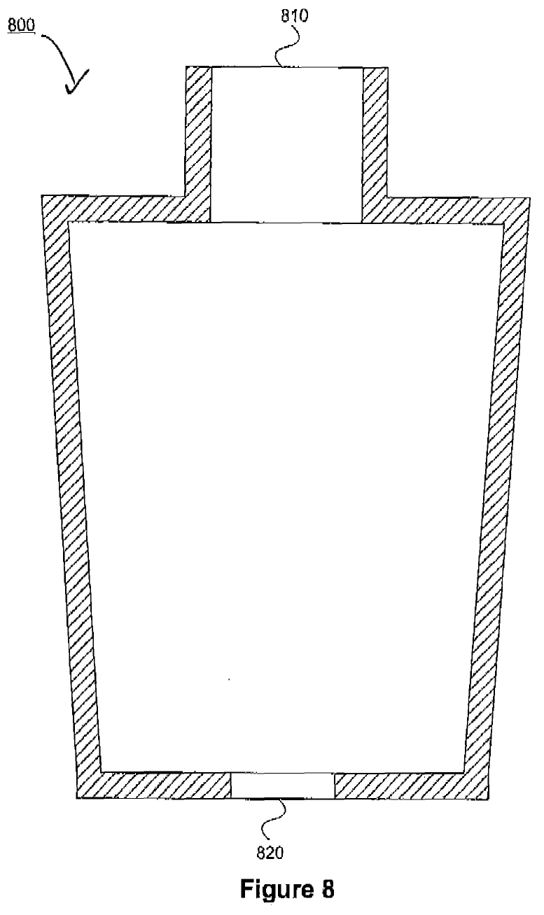

Referring to FIGS. 7 and 8, the outer surface 700 of the single use re-mineralization cartridge 800 appears similar to the cartridge 500 described above. The single use re-mineralization cartridge 800 is designed so that filtered, purified water enters the single use re-mineralization cartridge 800 at an inlet opening 810. The single use re-mineralization cartridge 800 includes a breakable mineral seal 820. The mineral seal 820 prevents water from exiting the single use re-mineralization and filter cartridge 800 until the mineral seal 820 is ruptured. In one example, the mineral seal 820 is formed from a single mineral seal. As the single use re-mineralization and filter cartridge 800 fills with water, the pressure of water contained in the filter cartridge 800 increases. This water's pressure continues to increases until it exceeds the threshold pressure required to causes the single mineral seal of mineral seal 820 to rupture. In one example, the mineral seal 820 is formed from two mineral seals that are ruptured when pierced by a needle. Before the mineral seal 820 ruptures, water that enters the re-mineralization cartridge 800 is re-mineralized by diluting the re-mineralization material contained within the re-mineralization cartridge 800 with the purified water that enters the re-mineralization cartridge 800. Once the mineral seal 820 is ruptured, purified water passing though the re-mineralization cartridge 800 is re-mineralized when it enters the collection reservoir 135 and combines with the re-mineralized and purified aqueous solution already contained in the final reservoir 135. Water continues to flow through the invention until the weight cell 197 determines that the final reservoir 135 is full and stops the flow of contaminated water through the pump 125.

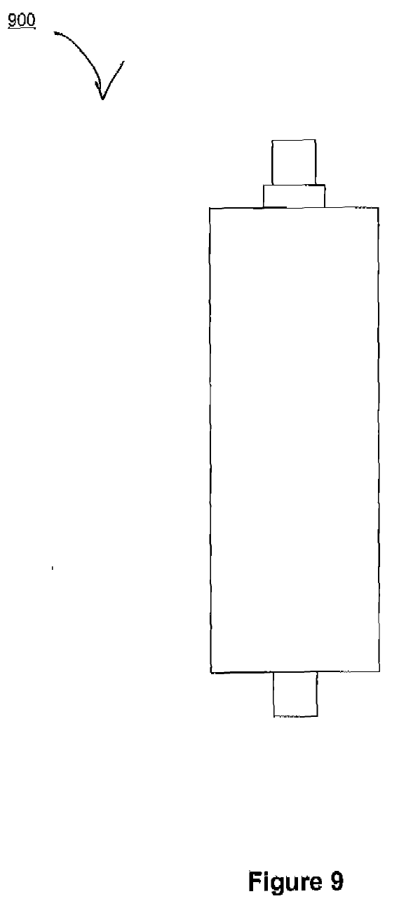

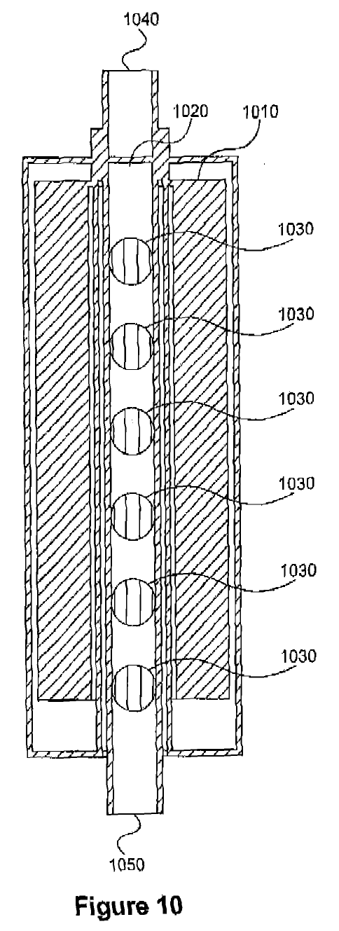

Referring to FIGS. 9 and 10, an outer surface 900 of the reverse osmosis filter 800 is shown. A cut-a-way view of reverse osmosis filter 1000 is used to illustrate how the impure water enters the reverse osmosis filter 1000 at the inlet opening 1040. The reverse osmosis filter 1000 purifies impure water as the impure water passes through the reverse osmosis membrane filter 1010. The now purified water exits the reverse osmosis membrane filter 1010 and enters a center tube 1020 via a plurality of centre tube holes 1030. The filtered, purified water exits the center tube 1020 at the exit 1050.

In certain examples that again are based on specific user use, additional sterility may be incorporated into the apparatus. Specifically, additional sterilization of the final water product in the collection reservoirs. To add more sterility to the final solution, the contaminated water is placed in an impure water storage space, and then exposed to an Ultraviolet light source such as a UVC Light Emitting Diode (LED). This LED will be appropriately electrically connected to the pump 125 and the power switch 210 if required. This LED will be a heat resistant light-producing device with a peak wavelength at around 405 nanometers. Certain examples used herein employ the UVC light source in the first reservoir 110. Other examples employ the UVC light source in the water bottle, i.e. the collection reservoir.

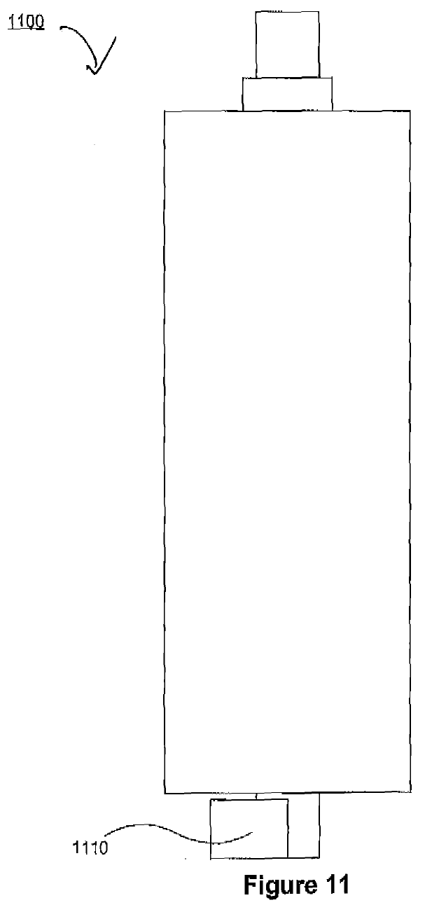

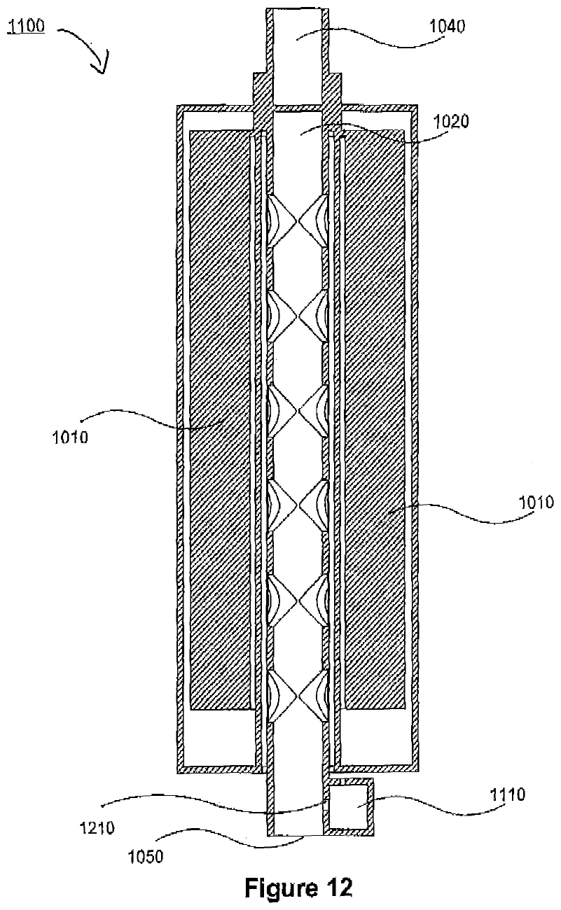

As best seen in FIGS. 11 and 12, a reverse osmosis membrane cartridge 1100 that includes a chamber 1110. The cartridge 1100 is used by a design of the apparatus that does not include a single use re-mineralization cartridge because the re-mineralization solution is contained in the chamber 1110 of the reverse osmosis membrane cartridge 1100. FIG. 12 shows a cut-away view of the reverse osmosis membrane cartridge 1100 in which the contaminated water enters the reverse osmosis membrane cartridge 1100 at the inlet opening 1040. The contaminated water is then filtered by the reverse osmosis filter 1010 before entering the center tube 1020. The re-mineralization solution in the chamber 1110 enters the center tube 1020 via an opening 1210 and mixes with the filtered water contained by the center tube 1020. The liquid concentrate located in the chamber 1110 is dispensed into the incoming stream of water in a slow and measured way which allows for a consistent and accurate remineralization of the purified water. The pressure from the incoming stream of water creates a suction effect (negative pressure) on the concentrate, and then the chamber 1110 slowly empties itself of the concentrate and is replaced by exterior air coming from a hole located on top of the chamber (not shown). Other mechanisms to dispense the concentrate directly into the flow of purified water are also known to those skilled in the art. A pneumatic system, which would diverge high pressure water to fill the chamber 1110 instead of air can also be created to provide the same result or a more accurate result than the previous embodiment.

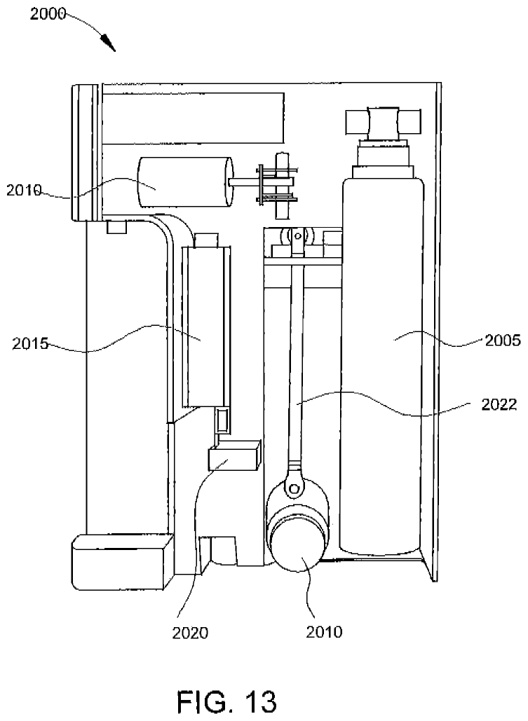

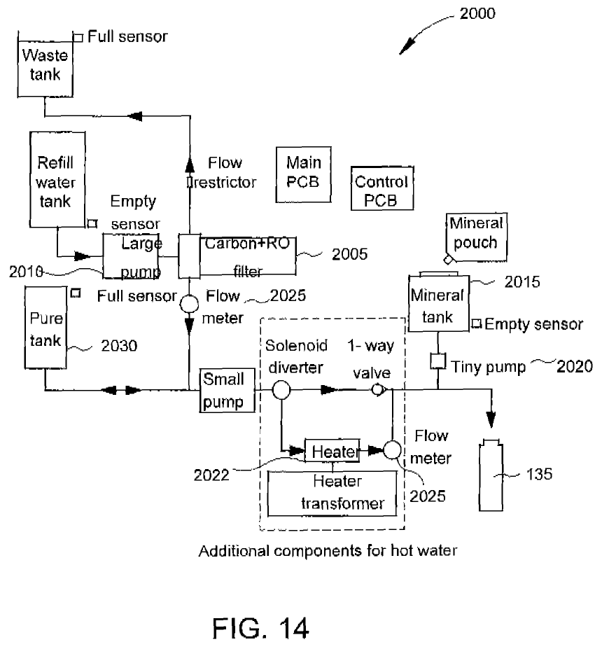

Referring now to FIGS. 13 and 14, there is shown an apparatus 2000 that includes a reverse osmosis booster diaphragm pump 2010 that can pressurize the apparatus to up to 130 PSI, and a peristaltic pump 2020 located to dispense the mineral concentrate from the dispensing cartridge 2015. A 3-in-1 carbon sediment and reverse osmosis filtration system 2005 is connected to a heating element 2022 via a flow meter 2025. The heating element 2022 is an instant heating module that may be used to provide boiling purified or mineralised water. The flow meter 2025 or flow rate sensor is included after the water purification components. A single switch (not shown) to control quantity dispensed (4 options: 200 mL, 500 mL, 1 L and custom amount). The layout of this alternative embodiment is best viewed in the circuit diagram of FIG. 14. The apparatus 2000 also includes an intermediary purified water tank 2030 that is located downstream of the cartridge. The intermediary purified water tank allows the collected purified water to be dispensed automatically as desired by the user. Thus, advantageously the user no longer needs to wait for the reverse osmosis process to occur each time (which can take about 3 mins/L

### Operation

Referring to FIG. 1, to begin the process of purification and re-mineralization, the user places the desired amount of impure water into the first reservoir 110 as illustrated by arrows 140 and 145. The user then activates the apparatus 100 to begin the purification and re-mineralization process by turning the power switch 210 to the “ON” position. Turning the power switch 210 to its “ON” position causes the pump 125 to draw impure water from the reservoir 110, through the tubing 120 and into the pump 125 as illustrated by arrows 150 and 155. The pump 125 then causes the impure water to exit the pump 125, through the tubing 130, and into the single use re-mineralization and filter cartridge 500 as illustrated by arrows 160, 165, and 170. The impure water enters the single use re-mineralization and filter cartridge 500 as illustrated by arrow 175. The impure water then enters a reverse osmosis filter membrane 510 as illustrated by arrows 180 and 185. As illustrated by arrow 190, the now purified, filtered water then passes through the center tube 520 where it is re-mineralized. The purified and re-mineralized aqueous solution exits the single use re-mineralization and filter cartridge 500 and enters the final collection reservoir 135 as illustrated by arrow 195.

Water that is re-mineralized in the center tube 520 prior to the mineral seal 550 being ruptured is re-mineralized by diluting the re-mineralization material contained within the center tube 520 with the purified water that passing through the center tube holes 530 of the center tube 520. Once the mineral seal 550 is ruptured, purified water passing though the center tube 520 is re-mineralized when it enters the final reservoir 135 and combines with the re-mineralized and purified aqueous solution already contained in the final reservoir 135. The purified and re-mineralized aqueous solution achieves the desired concentration of minerals and vitamins via this method so that this water is consumable. Impure water continues to be pumped into the single use re-mineralization and filter cartridge 500 by the pump 125 until the final reservoir 135 fills to the predefined level and the weight of the final reservoir 135 triggers the load sensor 197 to cause the pump 135 to stop pumping impure water into the single use re-mineralization and filter cartridge 500. Emptying the first reservoir 110 of impure water also stops the flow of contaminated water into the single use re-mineralization and filter cartridge 500.

Other and further aspects and advantages of the present invention will be obvious upon an understanding of the illustrative embodiments about to be described or will be indicated in the appended claims. Also, various advantages not referred to herein will occur to one skilled in the art upon employment of the invention in practice.

1-39. (canceled)

40. An apparatus for filtering and mineralizing a fluid, the apparatus comprising:
an amount of contaminated fluid located in a first reservoir;
a cartridge located downstream from the first reservoir and in fluid communication therewith;
a filter member in fluid communication with the first reservoir and the cartridge, the contaminated fluid being pumped along a fluid pathway from the first reservoir to the cartridge so that the contaminated fluid contacts the filter member and moves therethrough so as to generate an amount of a filtered fluid in the cartridge; and
a pre-determined amount of an additive material associated with the cartridge for adding to the filtered fluid so as to generate an amount of a final fluid having therein the amount of the additive material.

41. The apparatus, according to claim 40, further comprising:
i) a pump;
ii) a first conduit connected to the first reservoir and the pump; and,
iii) a second conduit connected to the pump and the cartridge;
wherein the filter member is located between the pump and the cartridge.

42. The apparatus, according to claim 41, wherein the filter member is a reverse osmosis filter.

43. The apparatus, according to claim 40, wherein the filter member is located between the first reservoir and the cartridge.

44. The apparatus, according to claim 40, wherein the additive material includes user specific minerals, vitamins, nutrients, and micro-nutrients.

45. The apparatus, according to claim 40, wherein the additive material is a liquid concentrate solution.

46. The apparatus, according to claim 41, wherein the pump pressurizes the first fluid to a predefined pressure between 80 PSI and 130 PSI pressure.

47. The apparatus, according to claim 40, further comprising a refrigeration unit to cool the filtered fluid and the final fluid exiting the cartridge, or an instant heating module to provide boiling purified or mineralised water.

48. The apparatus, according to claim 40, wherein a peristaltic pump connects the additive material to the cartridge so as to dispense additive material thereinto.

49. The apparatus, according to claim 40, further comprising a flow meter, a flow rate sensor, load cell and/or weight sensor located downstream of the cartridge.

50. The apparatus, according to claim 40, further comprising a UVC LED is located in the water holding tank to ensure that the purified water remains sterile while held in an intermediary tank

51. The apparatus, according to claim 40, wherein the fluid is water.

52. A process for filtering and mineralizing contaminated water, the process comprising:
filtering an amount of contaminated water from a first reservoir by pumping the contaminated water from the first reservoir through a filter member into a cartridge, the cartridge being located downstream of the first reservoir so as to generate an amount of filtered water; and
adding a predetermined amount of an additive material to the filtered water so as to generated a final water product, the pressure in the cartridge being sufficient to expel the final water product out of the cartridge and into a second reservoir.

53. The process, according to claim 52, wherein the pressure in the cartridge is between 80 PSI and 130 PSI.

54. The process, according to claim 52, wherein the additive material includes user specific minerals, vitamins, nutrients, and micro-nutrients.
